(19) United States
(12) Patent Application Publication
(10) Pub. No.: US 2026/0138074 A1
(43) Pub. Date: May 21, 2026

(54) CARBON DIOXIDE RECOVERY DEVICE

(71) Applicant: HONDA MOTOR CO., LTD., Tokyo (JP)

(72) Inventor: Hidetaka OZAWA, Saitama (JP)

(21) Appl. No.: 19/121,336

(22) PCT Filed: Oct. 23, 2023
(86) PCT No.: PCT/JP2023/038157

§ 371 Date: Apr. 15, 2025

(30) Foreign Application Priority Data
Nov. 11, 2022 (JP) 2022-181145

(51) Int. Cl. B01D 53/04; C01B 32/50

(52) U.S. Cl. CPC B01D 53/0454; B01D 53/0446; C01B 32/50; B01D 2253/20; B01D 2257/504; B01D 2258/06

(57) ABSTRACT

This carbon dioxide recovery device comprises: an air blower 20 that introduces the gas into the channel 11; an adsorption part 30 that adsorbs carbon dioxide contained in the air introduced into the channel 11; a driving force adjustment part that is provided to the air blower 20 and adjusts the flow rate of the air being introduced into the channel 11; a discharge-side carbon dioxide concentration sensor 43 that detects a carbon dioxide concentration Cₒᵤₜ in the air discharged from the channel 11; and a control unit 40 that adjusts, with the driving force adjustment part of the air blower 20, the flow rate of the gas being introduced into the channel 11 so that the carbon dioxide concentration Cₒᵤₜ in the air discharged from the channel 11 which is detected by the discharge-side carbon dioxide concentration sensor 43 is a given carbon dioxide concentration C_{obj}.

### TECHNICAL FIELD

The present invention relates to a carbon dioxide recovery device that recovers carbon dioxide from a gas containing carbon dioxide.

### BACKGROUND ART

As a conventional carbon dioxide recovery device, a device has been known that includes a main body having a flow path through which a gas containing carbon dioxide flows, a fan introducing the gas to the flow path, and an adsorption unit arranged in the flow path, and adsorbing carbon dioxide contained in the gas flowing through the flow path, in which the carbon dioxide is recovered from the gas by adsorbing the carbon dioxide contained in the gas introduced to the flow path by the fan onto the adsorption unit (for example, refer to U.S. Published Patent Application Publication, No. 2017/0106330).

The conventional carbon dioxide recovery device is configured so as to adsorb the carbon dioxide contained in the gas onto the adsorption unit, by bringing the gas introduced to the flow path into contact with the adsorption unit configured by supporting an adsorbent material such as an amine, for example, on a substrate.

Patent Document 1: U.S. Published Patent Application Publication, No. 2017/0106330, Specification

### DISCLOSURE OF THE INVENTION

### Problems to be Solved by the Invention

With the conventional carbon dioxide recovery device, efficient running of the fan is not possible over the entirety from start to stop of adsorption of carbon dioxide in the adsorption unit, due to introducing a constant flowrate of gas to the flow passage by a fan, and thus an energy savings cannot be achieved.

An object of the present invention is to provide a carbon dioxide recovery device which can achieve energy savings by efficiently driving a fan upon recovering carbon dioxide. Then, in turn, it contributes to the mitigation or influence reduction of climate change.

### Means for Solving the Problems

A carbon dioxide recovery device according to the present invention includes: a main body including a flow path through which a gas containing carbon dioxide flows; a blower that introduces the gas to the flow path; an adsorber that is arranged in the flow path and adsorbs the carbon dioxide contained in the gas introduced to the flow path; a flowrate adjuster that adjusts a flowrate of the gas introduced to the flow path; a discharge-side carbon dioxide concentration sensor that detects a concentration of carbon dioxide contained in a gas discharged from the flow path; and a controller that adjusts a flowrate of gas introduced to the flow path by way of the flowrate adjuster, so that a concentration of carbon dioxide contained in the gas discharged from the flow path detected by the discharge-side carbon dioxide concentration sensor becomes a predetermined concentration of carbon dioxide.

In addition, in the carbon dioxide recovery device according to the present invention, the flowrate adjuster is a fan constituting the blower, and adjusts the flowrate of the gas introduced to the flow path by adjusting a drive force thereof.

In addition, in the carbon dioxide recovery device according to the present invention, the blower includes a plurality of fans, and the flowrate adjuster adjusts a number of fans to drive among the plurality of fans.

### Effects of the Invention

According to the present invention, by holding the concentration of carbon dioxide contained in the air discharged from a flow path at a target carbon dioxide concentration, it becomes possible to maintain the adsorbed amount of carbon dioxide on the adsorption unit, and the fan can be efficiently driven in a relationship with the adsorbed amount of carbon dioxide. Therefore, energy savings can be achieved.

### BRIEF DESCRIPTION OF THE DRAWINGS

FIG. 1 is a schematic drawing of a carbon dioxide recovery device according to a first embodiment of the present invention;

FIG. 2 relates to the first embodiment of the present invention, with FIG. 2A being a graph showing the relationship between the time course and the adsorbed amount of carbon dioxide on an adsorbent material, FIG. 2B being a graph showing the relationship between the time course and the adsorption rate of carbon dioxide on the adsorbent material, and FIG. 2C being a graph showing the relationship between the adsorbed amount and the adsorption rate of carbon dioxide on the adsorbent material.

FIG. 3 relates to the first embodiment of the present invention, with FIG. 3A being a graph showing the relationship between the time course and the adsorbed amount of carbon dioxide on the adsorbent material for various air flows different from each other, and FIG. 3B being a graph showing the relationship between the time course and the adsorption rate of carbon dioxide on the adsorbent material for various air flows different from each other;

FIG. 4 is a graph showing a relationship between flow velocity of air and pressure loss according to the first embodiment of the present invention;

FIG. 5 relates to the first embodiment of the present invention, with FIG. 5A being a graph showing a relationship between the adsorbed amount of carbon dioxide on the adsorbent material and the flow velocity of air, and FIG. 5B being a graph showing the relationship between the flow velocity of air and the drive force of a fan;

FIG. 6 is a flowchart of air flow amount adjustment processing according to the first embodiment of the present invention;

FIG. 7 is a schematic diagram of a carbon dioxide recovery device according to a second embodiment of the present invention;

FIG. 8 is a flowchart of air flow amount adjustment processing according to the second embodiment of the present invention;

FIG. 9 is a schematic diagram of a carbon dioxide recovery device showing a state stopping part of the fans according to the second embodiment of the present invention;

FIG. 10 is a schematic diagram of a carbon dioxide recovery device according to a third embodiment of the present invention;

FIG. 11 is a graph showing the relationship between the adsorbed amount of carbon dioxide and the adsorption rate of each adsorption module according to the third embodiment of the present invention;

FIG. 12 is a drawing for explaining operation of each adsorption module according to the third embodiment of the present invention;

FIG. 13 provides graphs showing the relationship between the drive force of a fan and the carbon dioxide concentration in air discharged from a flow path, relationship between time course and the drive force of the fan, and relationship between the time course and the carbon dioxide concentration in air discharged from the flow path, according to the fourth embodiment of the present invention;

FIG. 14 is a graph showing the relationship between the drive force of the fan and the carbon dioxide concentration in air discharged from the flow path upon adjusting the drive force of the fan according to the fourth embodiment of the present invention;

FIG. 15 is a graph showing the relationship between the time course and the adsorbed amount of carbon dioxide in the case of the temperature of air introduced to the flow path changing, according to another embodiment;

FIG. 16 relates to another embodiment, with FIG. 16A being a graph showing the relationship between the time course and the adsorbed amount of carbon dioxide in the case of the adsorbent material deteriorating, and FIG. 16B being a graph showing the relationship between the time course and the adsorbed amount of carbon dioxide in the case of lowering the upper limit for the working capacity;

FIG. 17 is a perspective view of a heat exchanger that heats the adsorbent material according to another embodiment; and

FIG. 18 relates to another embodiment, with FIG. 18A being a graph showing the relationship between the time course and the adsorbed amount of carbon dioxide in the case of the upper limit and lower limit of the working capacity displacing in a direction approaching the equilibrium adsorption capacity, and FIG. 18B being a graph showing the relationship between the time course and the adsorbed amount of carbon dioxide in the case of the upper limit and lower limit of the working capacity displacing in a direction distancing from the equilibrium adsorption capacity.

### PREFERRED MODE FOR CARRYING OUT THE INVENTION

### First Embodiment

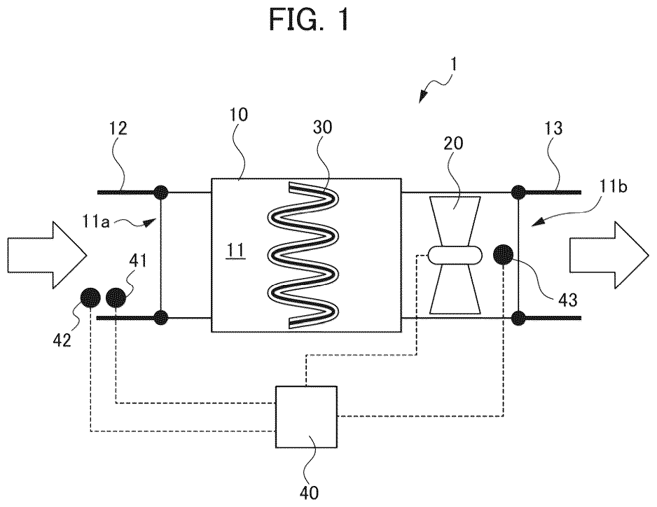

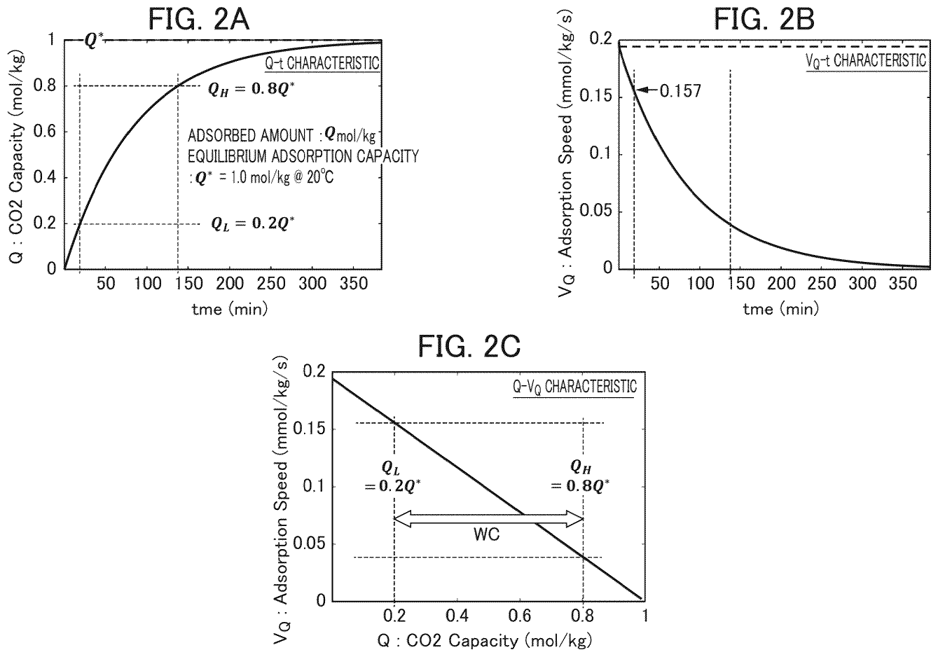

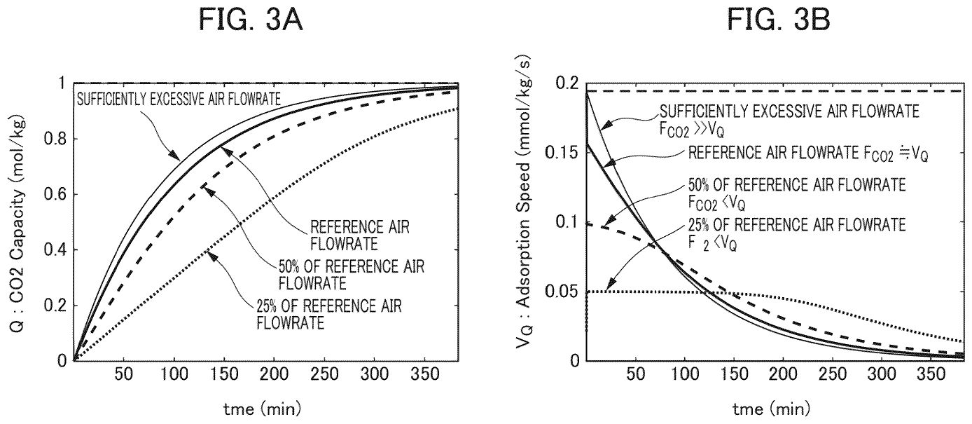

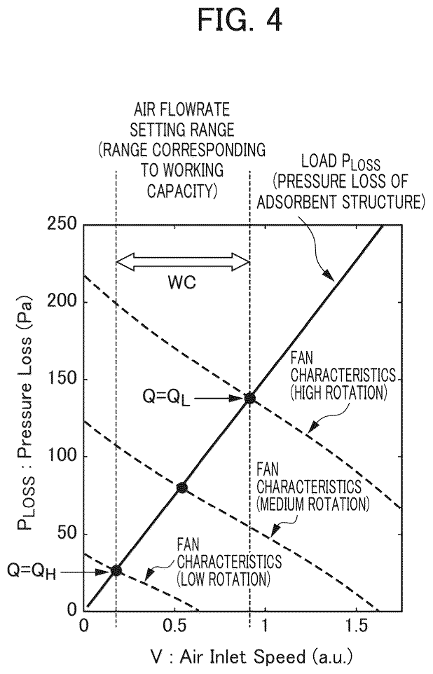

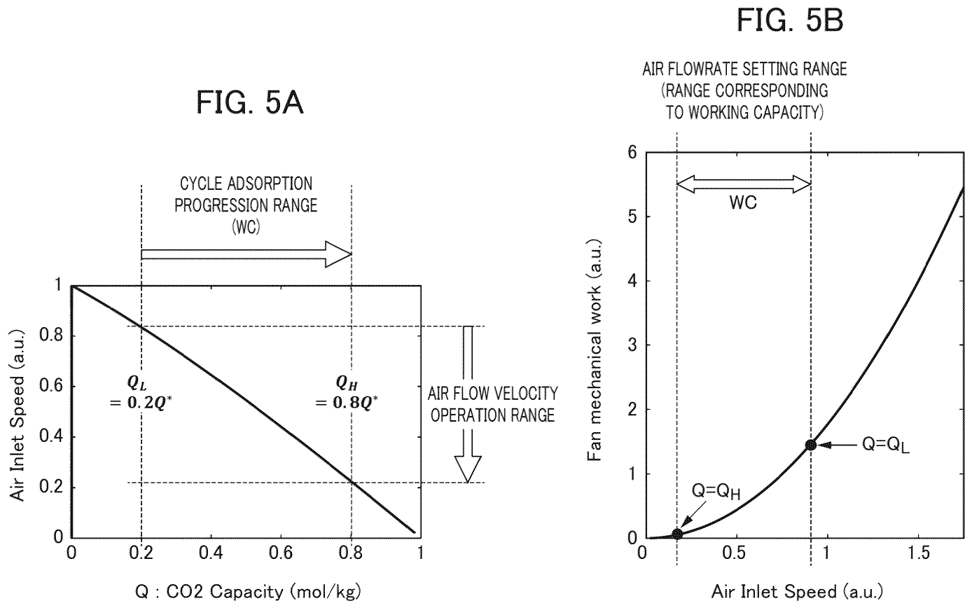

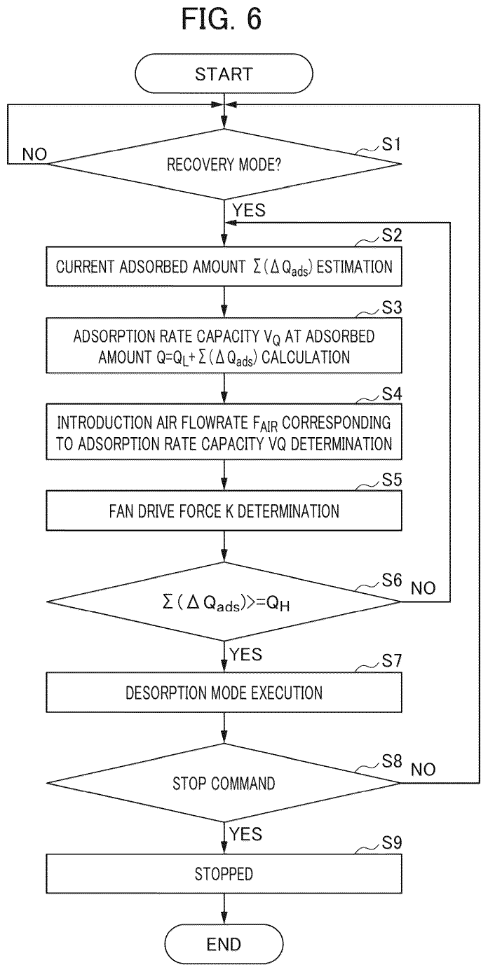

FIGS. 1 to 6 illustrate a first embodiment of the present invention. FIG. 1 is a schematic diagram of a carbon dioxide recovery device. FIG. 2A is a graph showing the relationship between the time course and the adsorbed amount of carbon dioxide on the adsorption material. FIB. 2B is a graph showing the relationship between the time course and the adsorption rate of carbon dioxide on the adsorption material. FIG. 2C is a graph showing the relationship between the adsorbed amount and the adsorption rate of carbon dioxide on the adsorption material. FIG. 3A is a graph showing the relationship between the time course and the adsorbed amount of carbon dioxide on the adsorption material at various air flows different from each other. FIG. 3B is a graph showing the relationship between the time course and the adsorption rate of carbon dioxide on the adsorption material at various air flows different from each other. FIG. 4 is a graph showing the relationship between the flow velocity of air and pressure loss. FIG. 5A is a graph showing the relationship between the adsorbed amount of carbon dioxide on the adsorption material and the flow velocity of air. FIG. 5B is a graph showing the relationship between the flow velocity of air and the drive force of a fan. FIG. 6 is a flowchart showing air flowrate adjustment processing.

A carbon dioxide recovery device 1 of the present embodiment, for example, is applied to direct air recovery technology (DAC: Direct Air Capture) which recovers the carbon dioxide in the atmosphere, in order to decrease the carbon dioxide concentration in the atmosphere. The carbon dioxide recovered by the carbon dioxide recovery device 1 is stored in the ground, for example, and is reused as a fuel or raw material.

As shown in FIG. 1, the carbon dioxide recovery device 1 includes a main body 10 having a flow path 11 in which air flows; a fan 20 as an air blower and a flowrate adjusting part for introducing air to the flow path 11; an adsorption unit 30 that is arranged in the flow path 11 and adsorbs carbon dioxide contained in the air introduced to the flow path 11; and a controller 40 for adjusting the flowrate of air introduced to the flow path 11 by controlling the drive force K of the fan 20.

The main body 10 consists of a box-shaped member in which the flow path 11 extends linearly. An air introduction port 11a for introducing air into the flow path 11, and an air discharge port 11b for discharging the air introduced to the flow path 11 are formed in the main body 10. An introduction-side opening/closing damper 12 for opening/closing the air introduction port 11a is provided at an edge portion of the air introduction port 11a of the main body 10. In addition, a discharge-side opening/closing damper 13 for opening/closing the air discharge port 11b is provided at an edge portion of the air discharge port 11b of the main body 10.

The fan 20 is an axial flow fan, for example, which is driven by an electric motor, and is arranged on a downstream side in an air circulation direction of the flow path 11. The fan 20 has a drive force adjusting part such as an inverter, for example, capable of varying the drive force K of the electric motor, and is capable of adjustment of the air flow by adjustment of the drive force K.

The adsorption unit 30 is configured by supporting an amine-system adsorbent material, for example, on a plate-shaped substrate permeable to air. The adsorption unit 30 has a larger contact area with air than the cross-sectional area of the flow path 11, by obliquely arranging a plurality of the plate-shaped substrates relative to the flow direction of air. A heater (not shown) for heating the adsorbent material upon desorbing the adsorbed carbon dioxide is provided to the adsorption unit 30.

The controller 40 includes a CPU, ROM, RAM, etc. When the controller 40 receives an input signal from devices connected on the input side, the CPU reads a program stored in the ROM based on the input signal, stores the state detected by the input signal in the RAM, and sends an output signal to devices connected on the output side.

As shown in FIG. 1, a flowrate sensor 41 for detecting the flowrate of air introduced to the flow path 11, an introduction-side carbon dioxide concentration sensor 42 for detecting the concentration of carbon dioxide contained in the air introduced to the flow path 11, and a discharge-side carbon dioxide concentration sensor 43 for detecting the concentration of carbon dioxide contained in the air discharged from the flow path 11 are connected to the input-side controller 40. In addition, the fan 20 is connected to the output side of the controller 40.

The carbon dioxide recovery device 1 configured in the above way alternately switches between and executes a recovery mode to adsorb and recover the carbon dioxide contained in the air to the adsorption unit 30, and a desorption mode to desorb the carbon dioxide adsorbed to the adsorption unit 30.

In the case of the carbon dioxide recovery device 1 operating in the recovery mode, the fan 20 is driven in a state in which the introduction-side opening/closing damper 12 opens the air introduction port 11a of the flow path 11, and the discharge-side opening/closing damper 13 opens the air discharge port 11b of the flow path 11.

The air is introduced from the air introduction port 11a to the flow path 11 of the main body 10, and the air after carbon dioxide is adsorbed in the adsorption unit 30 is discharged from the air discharge port 11b.

In addition, in the case of the carbon dioxide recovery device 1 operating in the desorption mode, the fan 20 is stopped in a state in which the introduction-side opening/closing damper 12 closes the air introduction port 11a of the flow path 11, and the discharge-side opening/closing damper 13 closes the air discharge port 11b of the flow path 11. Furthermore, in the desorption mode, by heating the adsorption unit 30 by a heater (not shown), and executing vacuum drawing of the flow path 11 with a vacuum pump (not shown), the carbon dioxide adsorbed to the adsorption unit 30 is desorbed.

Herein, with the fan 20 of the carbon dioxide recovery device 1 in the recovery mode, the air flow is adjusted according to the adsorbed amount of carbon dioxide adsorbed to the adsorption unit 30. The relationship between the adsorbed amount of carbon dioxide on the adsorption material of the adsorption unit 30 and the air flow of the fan 20 will be described below.

In the case of adsorbing carbon dioxide to the adsorption material constituting the adsorption unit 30 with a sufficiently large air flowrate F_{Air_excess} (mol/kg/s), when adsorbing the carbon dioxide to the adsorption material to near the equilibrium adsorption capacity Q* (mol/kg) (drawing illustrates with equilibrium adsorption capacity Q* set to 1 (mol/kg)), which is the maximum adsorbed amount, from a state in which the adsorbed amount Q (mol/kg) of carbon dioxide on the adsorption material is 0, the relationship between the time course t and the adsorbed amount Q of carbon dioxide will be as in FIG. 2A. In addition, the relationship between the time course t and the adsorption rate (referred to as adsorption rate capacity) V_{Q} (mol/kg/s), which is the adsorbed amount of carbon dioxide per unit time, will be as in FIG. 2B. Therefore, regarding the relationship between the adsorbed amount Q of adsorption material and the adsorption rate V_{Q}, the adsorption rate V_{Q} declines as the adsorbed amount Q increases, as in FIG. 2C.

In addition, the carbon dioxide recovery device 1 starts the recovery mode from an adsorbed amount Q_{L} which is 0.2 times of the equilibrium adsorption capacity Q* of the adsorption material, and ends the recovery mode at an adsorbed amount Q_{H} which is 0.8 times of the equilibrium update Q*, for example.

In addition, the carbon dioxide recovery device 1 starts the desorption mode from the adsorbed amount Q_{H} which is 0.8 times of the equilibrium adsorption capacity Q*, and ends the desorption mode at the adsorbed amount Q_{L} which is 0.2 times of the equilibrium adsorption capacity Q*. At this time, the range of the adsorbed amount Q_{L} which is 0.2 times to the adsorbed amount Q_{H} which is 0.8 times of the equilibrium adsorption capacity Q* of the adsorption material is called the working capacity (WC), and the carbon dioxide recovery device 1 switches between the recovery mode and desorption mode within the range of the working capacity. Herein, the working capacity is not limited to the range of the adsorbed amount Q_{L} which is 0.2 times to the adsorbed amount Q_{H} which is 0.8 times of the equilibrium adsorption capacity Q*, and may be within a predetermined range excluding the minimum value and maximum value of the adsorbed amount of carbon dioxide that can be adsorbed by the adsorption material. The working capacity, for example, may be set within the range of an adsorbed amount Q_{L} which is 0.1 times to an adsorbed amount Q_{H} which is 0.9 times of the equilibrium update Q* on the adsorption material.

In addition, in the case of adsorbing carbon dioxide to the adsorption material with a sufficiently large air flowrate F_{Air_excess}, the adsorption rate V_{Q} when reaching the adsorbed amount Q_{L} of carbon dioxide which is the lower limit of the working capacity becomes 0.157 (mol/kg/s), as shown in FIG. 2B. Herein, during the start of adsorption of carbon dioxide on the adsorption material, the air flowrate adjusted so that the adsorption rate becomes 0.157 (mol/kg/s) is defined as a reference air flowrate F_{Air_normal} (mol/kg/s).

FIG. 3A is a graph showing the relationship between the time course t and the adsorbed amount Q of carbon dioxide, at each of various air flows F different from each other. FIG. 3B is a graph showing the relationship between the time course t and the adsorption rate V_{Q} of carbon dioxide, at each of various air flows F different from each other.

As shown in FIGS. 3A and 3B, in the case of setting the air flowrate F at an excessive air flow larger than the reference air flowrate F_{Air_normal} (mol/kg/s), the relationship between the time course t and the adsorbed amount Q of carbon dioxide, and the relationship between the time course t and the adsorption rate V_{Q} of carbon dioxide are substantially the Same as the case of the reference air flowrate F_{Air_normal}. In other words, in the case of setting the air flowrate to larger than the reference air flow, since the adsorbed amount Q and adsorption rate V_{Q} of carbon dioxide relative to the time course t will not greatly increase, it is found that the running efficiency of the fan to circulate the air is low.

In addition, as shown in FIGS. 3A and 3B, in the case of setting the air flowrate F of the fan 20 to less than the reference air flowrate F_{Air_normal}, in a state in which the adsorbed amount Q of carbon dioxide is small, the adsorption rate V_{Q} of carbon dioxide will be lower than the adsorption rate V_{Q} at the reference air flowrate F_{Air_normal}. In other words, in the case of setting the air flowrate to less than the reference air flowrate, there is a portion in which the adsorption rate V_{Q} of carbon dioxide relative to the time course t is small, and the total adsorbed amount is also small; therefore, it is found that the adsorption capacity of the adsorption material is not sufficiently exhibited.

Furthermore, pressure loss of the flowing air occurs in the adsorption unit 30 in the flow path 11. For this reason, as in the graph showing the relationship between the flow velocity of air and pressure loss in FIG. 4, the fan 20 is driven at high revolution in a state in which the adsorbed amount Q of carbon dioxide on the adsorption unit 30 is small (lower limit side of working capacity), and is driven at low revolution in a state in which the adsorbed amount Q of carbon dioxide is large (upper limit side of working capacity). As shown in FIG. 5A, the flow velocity of air in the flow path 11 becomes smaller with an increase in adsorbed amount Q of carbon dioxide on the adsorption unit 30, and as shown in FIG. 5B, the drive force of the fan 20 also becomes smaller as the flow velocity of air in the flow path 11 becomes smaller.

The controller 40 performs air flowrate adjustment processing of adjusting the flowrate of air introduced to the flow path 11 by controlling the air flow of the fan 20 in the recovery mode, based on the aforementioned relationship between the adsorption material and the air flowrate. The operation of the controller 40 at this time will be described using the flowchart of FIG. 6.

### (Step S1)

In Step S1, the controller 40 determines whether the operation mode is the recovery mode, in the case of determining as being the recovery mode, advances the processing to Step S2, and in the case of not determining as being the recovery mode, repeats the processing of Step S1.

### (Step S2)

In the case of determining the operation mode as being the recovery mode in Step S1, the controller 40 in Step S2 estimates a current adsorbed amount 2 (ΔQ_{ads}) of carbon dioxide on the adsorption unit 30, and then advances the processing to Step S3.

Herein, the adsorbed amount Σ(ΔQ_{ads}) of carbon dioxide on the adsorption unit 30 is estimated based on the air flowrate F_{Air} introduced to the flow path 11 detected by the flowrate sensor 41, as well as the carbon dioxide concentration Cᵢₙ of air introduced to the flow path 11 detected by the introduction-side carbon dioxide concentration sensor 42, and a carbon dioxide concentration Cout of air discharged from the flow path 11 detected by the discharge-side carbon dioxide concentration sensor 43.

### (Step S3)

In Step S3, the controller 40 calculates the adsorption rate capacity V_{Q} based on the current adsorbed amount Σ(ΔQ_{ads}) of carbon dioxide estimated in Step S2, and then advances the processing to Step S4.

Herein, the adsorption rate capacity V_{Q} is calculated based on a numerical table representing the adsorption rate capacity V_{Q} relative to the adsorbed amount Σ(ΔQ_{ads}) of carbon dioxide on the adsorption unit 30.

### (Step S4)

In Step S4, the controller 40 determines the air flowrate F_{Air} introduced to the flow path 11 based on the adsorption rate capacity V_{Q} calculated in Step S3, and then advances the processing to Step S5.

Herein, the air flowrate F_{Air} introduced to the flow path 11 is determined from the relationship (F_{Air}=V_{Q}/Cᵢₙ) between the calculated adsorption rate capacity V_{Q} and the carbon dioxide concentration Cᵢₙ of air introduced to the flow path 11 detected by the introduction-side carbon dioxide concentration sensor 42.

### (Step S5)

In Step S5, the controller 40 sets the drive force K of the fan 20 based on the air flowrate F_{Air} introduced to the flow path 11 determined in Step S4, and then advances the processing to Step S6.

### (Step S6)

In Step S6, the controller 40 determines whether the current adsorbed amount Σ(ΔQ_{ads}) of carbon dioxide is an upper limit Q_{H} of the working capacity or more, in the case of determining that the adsorbed amount Σ(ΔQ_{ads}) is the upper limit Q_{H} of the working capacity or more, advances the processing to Step S7, and in the case of not determining as being the upper limit Q_{H} of the working capacity or more, returns the processing to Step S2.

### (Step S7)

In the case of determining that the current adsorbed amount Σ(ΔQ_{ads}) of carbon dioxide is an upper limit Q_{H} of the working capacity or more in Step S6, then in Step S7, the controller 40 switches the operation mode to the desorption mode, and advances the processing to Step S8.

### (Step S8)

In Step S8, the controller 40 determines whether a stop command has been inputted, and in the case of determining that a stop command has been inputted, advances the processing to Step S9, and in the case of not determining that a stop command has been inputted, returns the processing to Step S1.

### (Step S9)

In the case of determining that a stop command has been inputted in Step S8, then in Step S9, the controller 40 stops the carbon dioxide recovery device 1, and ends the air flowrate adjustment processing.

In this way, the carbon dioxide recovery device 1 of the present embodiment includes the main body 10 having the flow path 11 through which the air containing carbon dioxide flows, the fan 20 introducing air to the flow path 11, the adsorption unit 30 that is arranged in the flow path 11 and adsorbs the carbon dioxide contained in the air introduced to the flow path 11, a drive force adjustment part provided to the fan 20 that adjusts the flowrate of air introduced to the flow path 11, and the controller 40 that adjusts the flowrate of air introduced to the flow path 11 by way of the drive force adjustment part, based on changes in the adsorption rate capacity V_{Q}, which is the amount of carbon dioxide that can be adsorbed per unit time, which changes according to the adsorbed amount of carbon dioxide on the adsorption unit.

In addition, the adsorption unit 30 includes the adsorption material for which the adsorption rate capacity V_{Q} declines as the adsorbed amount Q of carbon dioxide increases, and the controller 40 causes the flowrate of air introduced to the flow path 11 to decrease by way of the drive force adjustment part with a decline in the adsorption rate capacity V_{Q}.

In addition, in a method of recovering the carbon dioxide contained in the air, the recovery process of adsorbing carbon dioxide to the adsorption unit 30, and the desorption process of desorbing the carbon dioxide adsorbed to the adsorption unit 30 in the recovery process are repeatedly and alternately executed, and the drive force of the fan 20 constituting the air blower is made to decline so as to reduce the flowrate of air to the adsorption unit 30 as time elapses, in each recovery process repeatedly executed.

Since it is thereby possible to efficiently drive the fan 20 by setting as a flowrate of air optimal to the adsorption of carbon dioxide on the adsorption unit 30 for which the adsorption rate capacity V_{Q} varies according to the adsorbed amount Q of carbon dioxide, energy savings can be achieved.

The flowrate adjustment unit is the fan 20 constituting the air blower, and adjusts the flowrate of air introduced to the flow path 11 by adjusting the drive force K.

It thereby becomes possible to reliably adjust the air flowrate in the flow path 11.

In addition, the controller 40 causes carbon dioxide to be adsorbed to the adsorption unit 30 within a predetermined range (working capacity) excluding a minimum value and a maximum value of the adsorbed amount Q of carbon dioxide that the adsorption unit 30 is capable of adsorbing.

It thereby becomes possible to cause the carbon dioxide to stably adsorb to the adsorption unit 30 irrespective of the maximum adsorbed amount Q and adsorption rate capacity V_{Q} of the adsorption unit 30 which vary according to environmental conditions.

In addition, the controller 40 acquires the adsorption rate capacity V_{Q} from the adsorbed amount Q, based on the numerical table representing the adsorption rate capacity V_{Q} relative to the adsorbed amount Q of carbon dioxide on the adsorption unit 30.

It thereby becomes possible to reduce the computational throughput of the controller 40, thereby enabling to use a lower cost control device.

### Second Embodiment

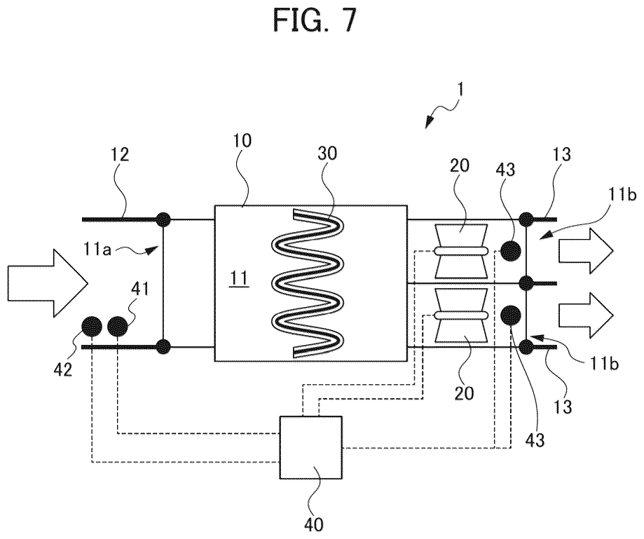

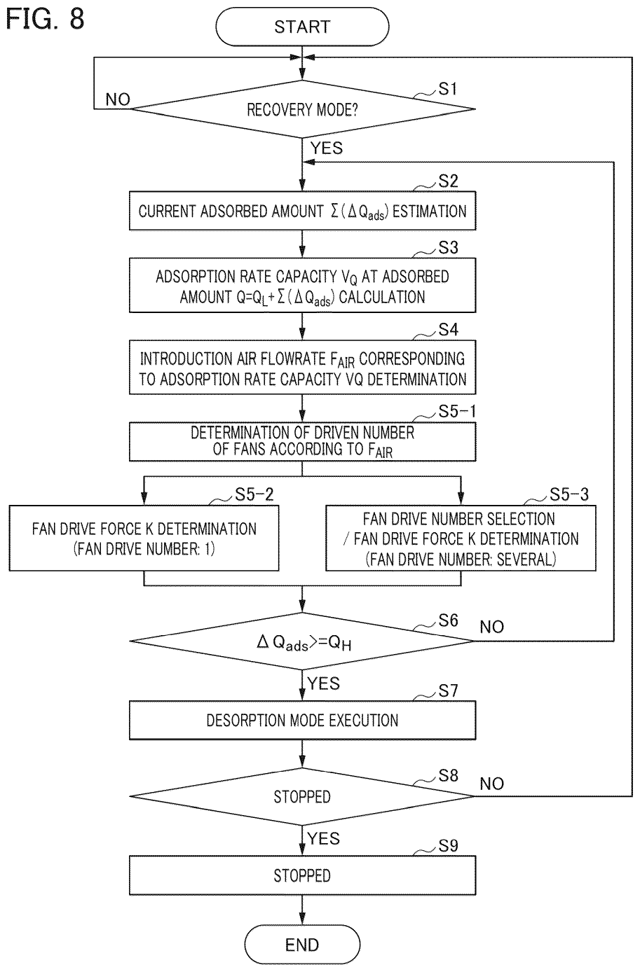

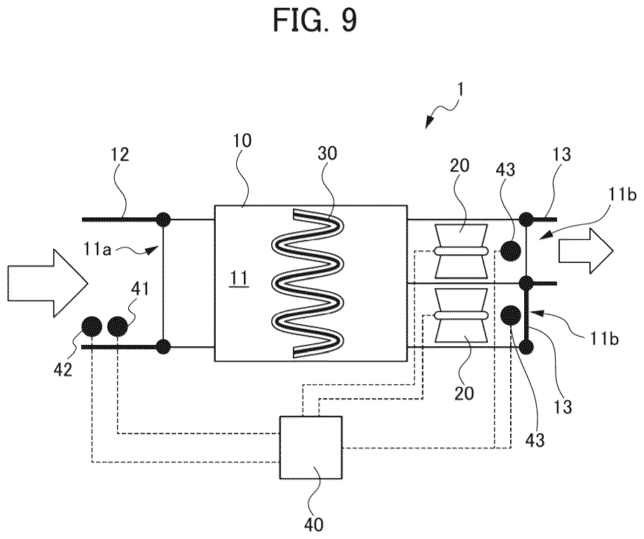

FIGS. 7 to 9 show a second embodiment of the present invention. FIG. 7 is a schematic drawing of a carbon dioxide recovery device. FIG. 8 is a flowchart showing air flowrate adjustment processing. FIG. 9 is a schematic drawing of a carbon dioxide recovery device showing a state stopping part of the fans. Note that the same reference symbols are assigned to constituent portions similar to the above-mentioned embodiment.

In the carbon dioxide recovery device 1 of the present embodiment, a plurality of fans 20 as the air blower and flowrate adjustment units are provided on a downstream side in the air circulation direction of the flow path 11 in the main body 10.

In addition, a discharge-side carbon dioxide concentration sensor 43 and a discharge-side opening/closing damper 13 are respectively provided on the downstream side of each of the plurality of fans 20 in the main body 10.

In the carbon dioxide recovery device 1 configured in the above way, the controller 40 performs air flowrate adjustment processing of adjusting the flowrate of air introduced to the flow path 11 by controlling the operating number of the plurality of fans 20 and the air flow of fans 20, in the recovery mode. The operation of the controller 40 at this time will be described using the flowchart of FIG. 8 for portions differing from the first embodiment.

### (Step S5-1)

In Step S5-1, the controller 40 determines the operating number of the fans 20 based on the air flowrate F_{Air} introducing to the flow path 11 determined in Step S4, and then advances the processing to Step S5-2 or Step S5-3.

### (Step S5-2)

In the case of the operating number of fans 20 determined in Step S5-1 being one unit, then in Step S5-2, the controller 40 sets the drive force K of the fan 20 to be driven, and then advances the processing to Step S6.

Herein, in the case of the operating number of the fans 20 being one unit, as shown in FIG. 9, the driving of the fans 20 to stop running is stopped, and the discharge-side opening/closing damper 13 corresponding to the fan 20 to stop running is closed.

### (Step S5-3)

In the case of the operating number of fans determined in Step S5-1 being several, then in Step S5-3, the controller 40 sets the number of fans 20 to drive and the drive force K of each of the fans 20 to drive, and then advances the processing to Step S6.

In this way, the carbon dioxide recovery device 1 of the present embodiment can efficiently drive the fans 20 by circulating air of a flowrate optimal to the adsorption of carbon dioxide in the flow path 11, relative to the adsorption unit 30 having an adsorption rate capacity V_{Q} which varies according to the adsorbed amount Q of carbon dioxide, similarly to the above-mentioned embodiment, and thus energy savings can be achieved.

In addition, the air blower consists of a plurality of fans 20, and the flowrate adjustment unit adjusts the number of fans 20 to drive among the plurality of fans 20.

Since it is thereby possible to introduce air of the optimal flowrate for the adsorption of carbon dioxide to the flow path 11 by varying the operating number of fans 20, in the case of the necessary flowrate of air being small, it is possible to further reduce the energy consumption for driving the fans 20.

### Third Embodiment

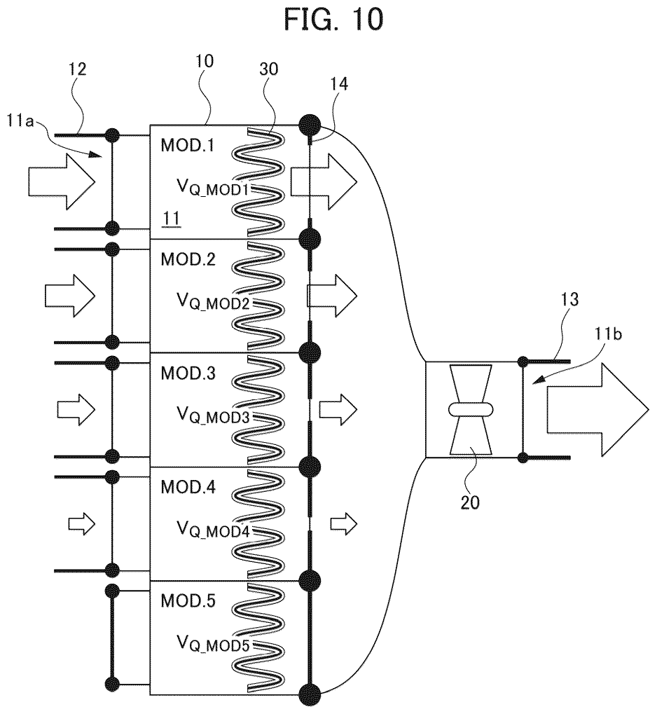

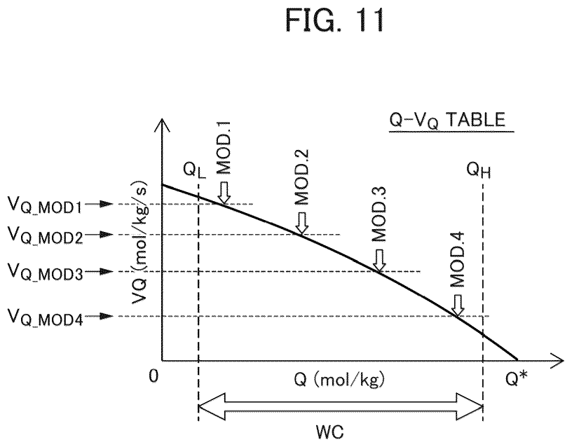

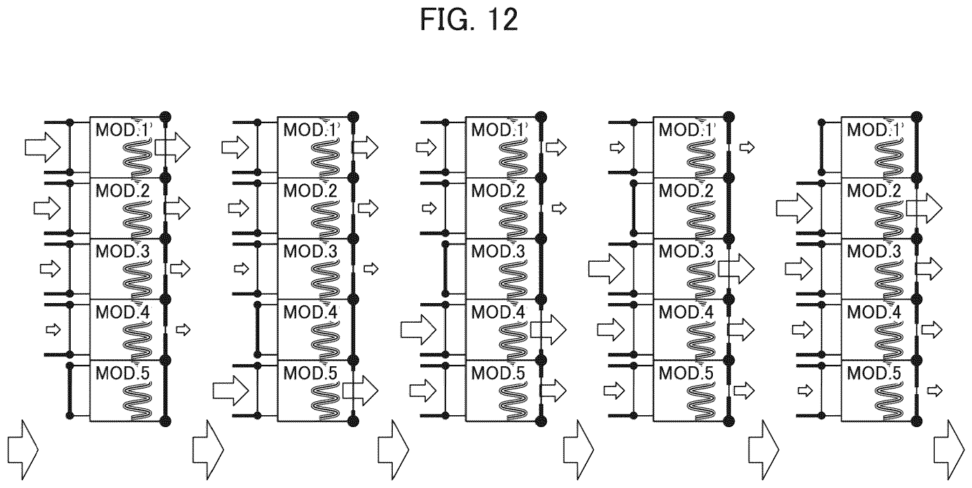

FIGS. 10 to 12 show a third embodiment of the present invention. FIG. 10 is a schematic diagram of a carbon dioxide recovery device. FIG. 11 is a graph showing the relationship between the adsorbed amount of carbon dioxide of each adsorption module and the adsorption rate. FIG. 12 is a view illustrating the operation of each adsorption module. Note that the same reference symbols are assigned to constituent portions similar to the above-mentioned embodiment.

The carbon dioxide recovery device 1 of the present embodiment includes a plurality of adsorption modules (In FIG. 10, MOD.1, MOD.2, MOD.3, MOD.4, MOD.5), each having the main body 10 and the adsorption unit 30, and in which the flow paths 11 of each are arranged in parallel to each other.

In addition, in the carbon dioxide recovery device 1, one air discharge port 11b is provided relative to the plurality of adsorption modules, and the discharge-side opening/closing damper 13 is provided at the edge portion of the air discharge port 11b.

Furthermore, in the carbon dioxide recovery device 1, the fan 20 is arranged as an air blower on the downstream side of the flow paths 11 of the plurality of adsorption modules, and one fan 20 is arranged relative to the plurality of adsorption modules.

An aperture adjustment damper 14 as a flowrate adjustment unit that adjustably opens and closes the aperture is provided in each of the flow paths 11 of the plurality of adsorption modules, between the adsorption unit 30 of each of the plurality of adsorption modules and the fan 20.

Each of the plurality of adsorption modules of the carbon dioxide recovery device 1 configured in the above way operates while switching between recovery mode and desorption mode.

Herein, for example, in the case of the time necessary in the recovery mode being 4 times the time necessary in the desorption mode, a carbon dioxide recovery device 1 including five adsorption modules is configured as shown in FIG. 10. In the carbon dioxide recovery device 1 including five adsorption modules, four of the adsorption modules (in FIG. 10, MOD.1, MOD.2, MOD.3 and MOD.4) are operating in the recovery mode, and one adsorption module (in FIG. 10, MOD.5) is run in the desorption mode.

In addition, for the four adsorption modules running in the recovery mode, the aperture of the aperture adjustment damper 14 of each of the plurality of adsorption modules is adjusted, so as to achieve an air flowrate F_{Air} introduced to the flow path 11 according to the adsorption rate capacity V_{Q} of the adsorption unit 30, relative to each of the plurality of adsorption modules.

At this time, by starting the recovery mode at different times from each other with the four adsorption modules in the recovery mode, it is configured so that the adsorption rate capacity V_{Q} of each is different, and configured so as to differentiate the times at which switching from the recovery mode to the desorption mode, as in the graph showing the relationship between the adsorbed amount Q of carbon dioxide and the adsorption rate capacity V_{Q} shown in FIG. 11.

FIG. 12 is showing the change accompanying the elapse of time of the air flowrate F_{Air} introduced to the flow path 11, for each of the adsorption modules. The size of the white arrow of each adsorption module in FIG. 12 indicates the magnitude of the air flowrate Fₐᵢᵣ. Herein, the adsorption module running in the desorption mode switches in the order of MOD.5, MOD.4, MOD.3, MOD.2 and MOD.1 accompanying the elapse of time, as shown in FIG. 12. At this time, the adsorption modules in the recovery mode are adjusted so that the respective air flowrates F_{Air} thereof are different. The total flowrate of air supplied to each of the plurality of adsorption modules is thereby always a constant flowrate. At this time, the fans 20 are driven with a constant drive force K.

In this way, according to the carbon dioxide recovery device 1 of the present embodiment, by circulating air of a flowrate optimal to the adsorption of carbon dioxide in the flow path 11, for the adsorption unit 30 for which the adsorption rate capacity V_{Q} varies according to the adsorbed amount Q of carbon dioxide, it is possible to efficiently drive the fans 20, similarly to the above-mentioned embodiment, and thus energy savings can be achieved.

In addition, by including a plurality of adsorption modules each having the main body 10 and the adsorption unit 30, and having the flow paths 11 of each arranged in parallel with each other, the air blower is maintained at a predetermined air quantity to introduce a gas to the flow path 11 of each of the plurality of adsorption modules, and the flowrate adjustment unit is a flowrate adjustment damper provided to each of the plurality of adsorption modules, and capable of adjusting the flowrate of the gas introduced to the flow path 11.

In a state setting the total flowrate of air of the plurality of adsorption modules as a fixed flowrate, it is possible to circulate the optimal flowrate of air in each of the adsorption modules in the flow path 11, and it is unnecessary to vary the air flow. Therefore, the fan 20 can be more efficiently operated.

### Fourth Embodiment

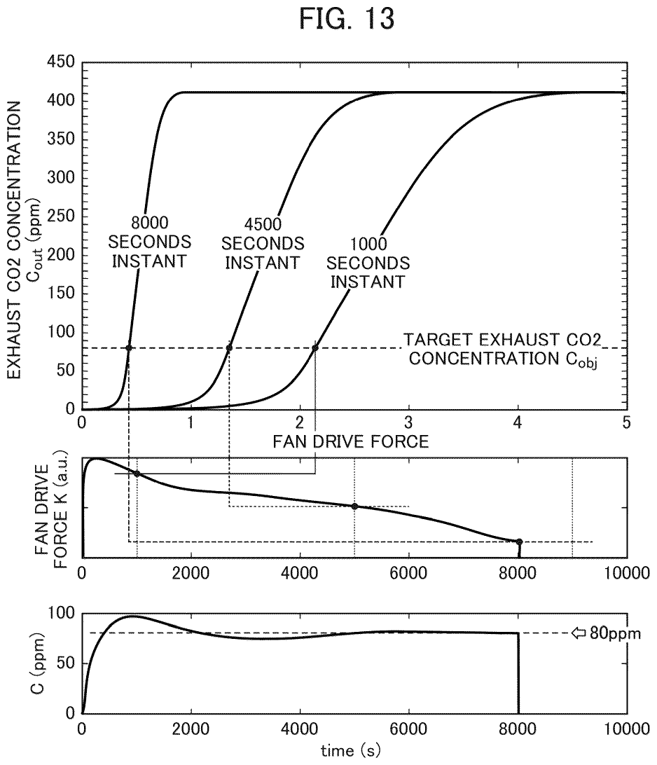

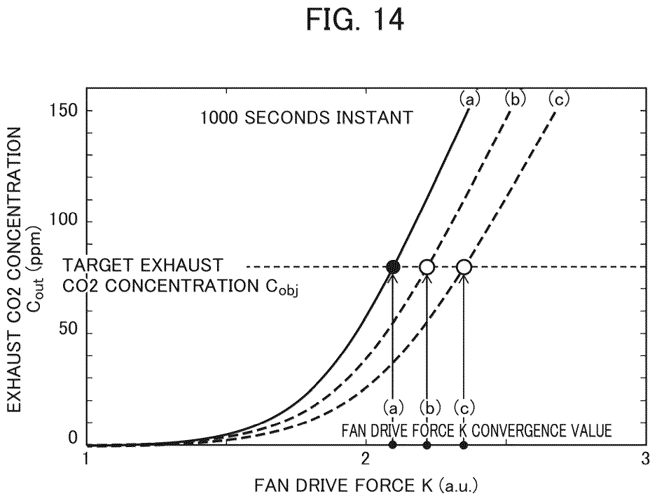

FIGS. 13 and 14 show a fourth embodiment of the present invention. FIG. 13 is a graph showing the relationship between the drive force of a fan and the carbon dioxide concentration in air discharged from a flow path, the relationship between the time course and the drive force of the fan, and the relationship between the time course and the carbon dioxide concentration in air discharged from the flow path. FIG. 14 is a graph showing the relationship between the drive force of the fan and the carbon dioxide concentration in air discharged from the flow path upon adjusting the drive force of the fan.

Note that the same reference symbols are assigned to constituent portions similar to the above-mentioned embodiment.

The carbon dioxide recovery device 1 of the present embodiment has a similar configuration to the first embodiment (FIG. 1).

The controller 40 performs control to continue the recovery mode until the adsorbed amount Σ(ΔQ_{ads}) of carbon dioxide on the adsorption unit 30 reaches the upper limit Q_{H} of the working capacity, and performs feedback control adjusting the drive force K of the fan 20 so that the carbon dioxide concentration Cₒᵤₜ of air discharged from the flow path 11 reaches a predetermined objective carbon dioxide concentration C_{obj} in the vicinity of 0 ppm, such as 80 ppm (ΔC=C_{obj}−Cₒᵤₜ), for example.

In other words, the controller 40 detects the carbon dioxide concentration Cₒᵤₜ of air discharged from the flow path 11 by way of the discharge-side carbon dioxide concentration sensor 43, and adjusts the introduction amount of air introduced to the flow path 11 by adjusting the drive force K of the fan 20 so that the detected carbon dioxide concentration Cₒᵤₜ of air reaches the objective carbon dioxide concentration C_{obj}.

Herein, in a state setting the flowrate of air introduced to the flow path 11 at the reference air flowrate, in the case of the time in the recovery mode adsorbing carbon dioxide to the adsorption unit 30 from the lower limit Q_{L} to the upper limit Q_{H} of the working capacity requiring 8,000 seconds, the relationship between the drive force of the fan 20 and the objective carbon dioxide concentration C_{obj} is shown at the top of FIG. 13. The top of FIG. 13 shows that, at the time of 1,000 seconds, the drive force K of the fan 20 reaching the objective carbon dioxide concentration C_{obj} is large since the adsorption rate capacity V_{Q} of the adsorption unit 30 is large. It also shows that, at the time of 4,500 seconds and the time of 8,000 seconds, the adsorption rate capacity V_{Q} of the adsorption unit 30 becomes smaller with the elapse of time, and the drive force K of the fan 20 reaching the objective carbon dioxide concentration C_{obj} also becomes smaller.

At this time, the drive force K of the fan 20 becomes smaller with the elapse of time, as shown in the middle of FIG. 13. In addition, the carbon dioxide concentration Cₒᵤₜ of air discharged from the flow path 11 converges to 80 ppm with the elapse of time, as shown in the bottom of FIG. 13.

In addition, due to the adsorptive power of carbon dioxide on the adsorption unit 30 declines from aged deterioration of the adsorption unit 30, such as a decline in adsorptivity of carbon dioxide of the adsorption material, and the fan 20 undergoing aged deterioration, the relationship between the drive force K of the fan 20 and the carbon dioxide concentration Cₒᵤₜ of air discharged from the flow path 11 is considered to change. Accompanying aged deterioration of this adsorption unit 30 and the fan 20, the relationship between the drive force K of the fan 20 and the carbon dioxide concentration Cₒᵤₜ changes in the order of curve (a), curve (b) and curve (c) with the elapse of time, as shown in FIG. 14, and the drive force K of the fan 20 required to achieve the carbon dioxide concentration Cₒᵤₜ becomes larger. In this way, even in the case of aged deterioration occurring in the adsorption unit 30 and the fan 20, the carbon dioxide concentration Cₒᵤₜ of air discharged from the flow path 11 is maintained at the objective carbon dioxide concentration C_{obj}, by adjustment of the drive force K of the fan 20.

In this way, the carbon dioxide recovery device 1 of the present embodiment includes: the main body 10 having the flow path through which a gas containing carbon dioxide flows; the fan 20 introducing the gas to the flow path 11; the adsorption unit 30 that is arranged in the flow path 11 and adsorbs the carbon dioxide contained in the air introduced to the flow path 11; the drive force adjustment part provided to the fan 20 adjusting the flowrate of air introduced to the flow path 11; the discharge-side carbon dioxide concentration sensor 43 that detects the concentration Cₒᵤₜ of carbon dioxide contained in air discharged from the flow path 11; and the controller 40 that adjusts the flowrate of the gas introduced to the flow path 11 by the drive force adjustment part of the fan 20, so that the concentration Cₒᵤₜ of carbon dioxide contained in the air discharged from the flow path 11 detected by the discharge-side carbon dioxide concentration sensor 43 becomes the predetermined concentration C_{obj} of carbon dioxide.

Thereby, by maintaining the concentration Cₒᵤₜ of carbon dioxide contained in the air discharged from the flow path 11 at the objective carbon dioxide concentration C_{obj}, it is thereby possible to maintain the adsorbed amount of carbon dioxide on the adsorption unit 30, and the fan 20 can be efficiently driven in the relationship with the adsorbed amount of the carbon dioxide, and thus energy savings can be achieved.

In addition, the flowrate adjustment unit is the fan 20, and adjusts the flowrate of air introduced to the flow path 11 by adjusting the drive force.

It thereby becomes possible to reliably adjust the air flowrate in the flow path 11.

Additionally, the fourth embodiment illustrates the carbon dioxide recovery device 1 including one fan 20 as the air blower; however, it is not to be limited thereto. For example, as shown in FIG. 7, it is also applicable to the carbon dioxide recovery device 1 of the second embodiment including a plurality of fans 20 as the air blower. In this case, by adjusting the number of fans 20 to drive among the plurality of fans 20, it may be configured so as to adjust the flowrate of air introduced to the flow path 11, so that the carbon dioxide concentration Cₒᵤₜ of air discharged from the flow path 11 becomes the objective carbon dioxide concentration C_{obj}. By changing the operating number of fans 20, since it is possible to introduce air of a flowrate optimal to adsorption of carbon dioxide to the flow path 11, in the case of the required flowrate of air being small, it becomes possible to further reduce the consumption of energy driving the flower 20.

In addition, as shown in FIG. 10, in the case of applying to the carbon dioxide recovery device 1 of the third embodiment which includes a plurality of adsorption modules, by adjusting the aperture of the flow path 11 of each of the plurality of adsorption modules using the aperture adjustment damper 14, it may be configured to adjust the flowrate of air introduced to the flow path 11 of each of the adsorption modules, so that the carbon dioxide concentration Cₒᵤₜ of air discharged from the flow path 11 becomes the objective carbon dioxide concentration C_{obj}.

### Other Embodiments

As another embodiment, in the carbon dioxide recovery device shown in FIG. 1, the drive force K of the fan 20 is controlled based on the flowrate of air introduced to the flow path 11 detected by a flowrate sensor 41.

When the carbon dioxide recovery device is installed outdoors, in the case of being affected by outdoor wind, the adjustment of flowrate of air introduced to the flow path becomes possible.

In addition, the carbon dioxide recovery device includes a numerical table for the adsorption material of the adsorption unit representing the relationship between the relative humidity and adsorbed amount of moisture, and the relationship between the temperature and adsorbed amount of moisture, and in the desorption mode, the heat quantity required for desorbing carbon dioxide adsorbed by the adsorption unit and the heat quantity required for desorbing moisture adsorbed by the adsorption unit are added to a heat adsorption unit. For example, by supplying low-pressure superheated steam at 5 kPa and 81° C. (10% relative humidity) to the heat adsorption unit, the carbon dioxide and moisture are desorbed from the heat adsorption unit.

When the carbon dioxide recovery device is installed outdoors, in the case of being affected by moisture in the air outdoors, it is possible to reliably desorb the carbon dioxide and moisture from the heat adsorption unit.

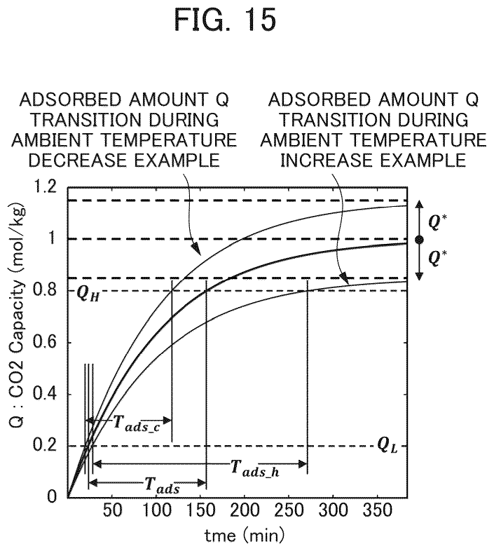

In addition, if the temperature of outdoors in which the carbon dioxide recovery device is installed is high, and the temperature of air introduced to the flow path 11 is higher than a reference temperature, as shown in FIG. 15, the equilibrium adsorption capacity of carbon dioxide on the adsorption unit in the recovery mode declines, and the time until achieving the upper limit Q_{H} of the working capacity may lengthen. On the other hand, the heat quantity required for heating the heat adsorption unit in the desorption mode becomes smaller. In such a case, by extending the operating time in the recovery mode, and extending the operating time of the fan, it becomes possible to maintain the range of the working capacity. It thereby becomes possible to suppress a decrease in the adsorbed amount of carbon dioxide in the recovery mode.

Furthermore, when the temperature of the outdoors in which the carbon dioxide recovery device is installed is low, and the temperature of the air introduced to the flow path 11 becomes lower than a reference temperature, as shown in FIG. 15, the equilibrium adsorption capacity of carbon dioxide on the adsorption unit in the recovery mode rises, and the time until achieving the upper limit Q_{H} of the working capacity may shorten. On the other hand, the heat quantity required for heating the heat adsorption unit in the desorption mode becomes larger. In such a case, by shortening the operating time in the recovery mode, and shortening the operating time of the fan, it becomes possible to maintain the range of the working capacity. It thereby becomes possible to suppress a decrease in the adsorbed amount of carbon dioxide in the recovery mode.

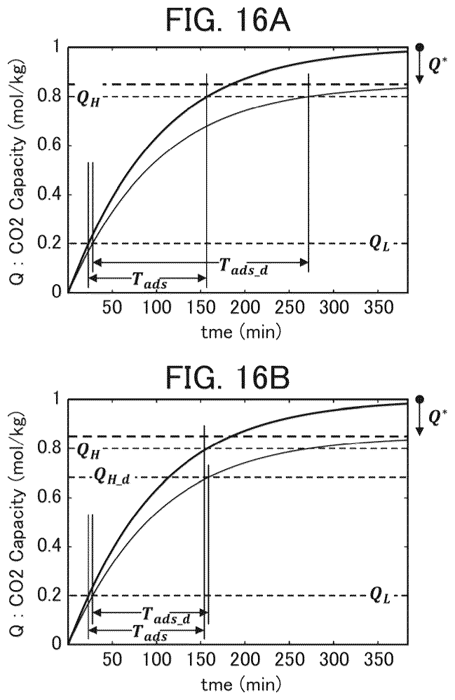

In addition, when the equilibrium adsorption capacity Q* becomes smaller due to aged deterioration of the adsorption material of the adsorption unit in the carbon dioxide recovery device, as shown in FIG. 16A, the time Tads a reaching the upper limit Q_{H} of the working capacity in the recovery mode becomes longer than a reference time Tads. In this case, with the carbon dioxide recovery device, the energy amount for driving the fan will increase, and the total amount recovering carbon dioxide decreases. For this reason, with the carbon dioxide recovery device, in the case of the time reaching the upper limit Q_{H} of the working capacity becomes a predetermined time or more, it is determined as the lifespan of the adsorption unit. By exchanging the adsorption unit based on the determination of the lifespan of the adsorption unit, the carbon dioxide recovery device becomes able to perform normal operation.

In addition, in the case of the equilibrium adsorption capacity Q* of carbon dioxide becoming small due to the adsorption material of the adsorption unit in the carbon dioxide recovery device undergoing aged deterioration, the upper limit Q_{H} of the working capacity may be made to decrease to an upper limit Q_{H_d}, as shown in FIG. 16B, in order to maintain the operating time in the recovery mode. In this case, by repeating the recovery mode with the carbon dioxide recovery device, the upper limit of the working capacity declines. For this reason, the carbon dioxide recovery device determines the lifespan of the adsorption unit, in the case of the upper limit of the working capacity becoming a predetermined value or less. The carbon dioxide recovery device can perform normal operation by exchanging the adsorption unit based on the determination of the lifespan of the adsorption unit.

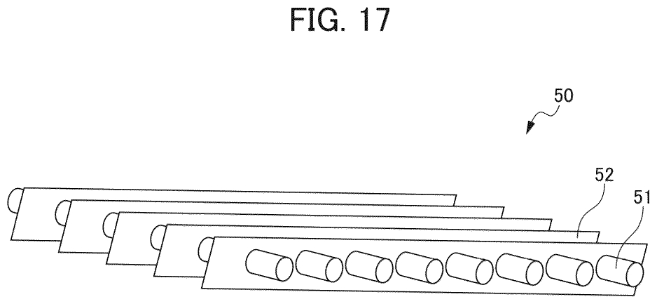

In addition, in order to desorb the carbon dioxide adsorbed to the adsorption material of the adsorption unit, as shown in FIG. 17, the carbon dioxide recovery device may arrange, within the adsorption material, a heat exchanger 50 consisting of a tube 51 through which a cooling medium flows, and a plurality of fins 52 provided to the outer circumferential surface of the tube 51. In this case, since it is a state in which the adsorption material is maintained in the gaps between the plurality of fins 52 constituting the heat exchanger 50, it becomes possible to suppress uneven distribution of the granular adsorption material.

On the other hand, in the case of supplying steam directly to the adsorption material in order to desorb the carbon dioxide adsorbed to the adsorption material of the adsorption unit, there is a possibility of uneven distribution of the granular adsorption material occurring in the adsorption unit. In the case of the uneven distribution of the adsorption material occurring in the adsorption unit, since air will flow around portions having decreased density of the adsorption material, the relationship between the work and revolution speed of the fan will deviate from the normal range. For this reason, the extent of uneven distribution of the adsorption material is determined based on the relationship between the work and revolution speed of the fan, and in the case of the extent of uneven distribution of the adsorption material surpassing a predetermined range, the adsorption material may be refilled into the adsorption unit to eliminate the uneven distribution of adsorption material in the adsorption unit.

In addition, based on the difference between the required air flowrate, which is the required flowrate of air introduced to the flow path, and the actual flowrate of air introduced to the flow path, the carbon dioxide recovery device may control the air flow of the fan so that the actual flowrate of air introduced to the flow path becomes the required air flowrate. In the case of the air flow of the fan becoming larger by repeating operation of the recovery mode, the carbon dioxide recovery device determines that a defect such as dirt on the fan is occurring. By performing maintenance of the fan based on the determination of a defect in the fan, the carbon dioxide recovery device becomes able to perform normal operation.

In addition, by calculating an instant adsorbed amount ΔQ_{ads}of carbon dioxide based on the flowrate Fₐᵢᵣ of air introduced to the flow path, the carbon dioxide concentration Cᵢₙ of air introduced to the flow path and the carbon dioxide concentration Cₒᵤₜ of air discharged from the flow path, and then successively integrating this, the carbon dioxide recovery device calculates the adsorbed amount Σ(ΔQ_{ads}) of carbon dioxide on the adsorption unit, and estimates the adsorbed amount Q of carbon dioxide at the current time by adding this to Q_{L} (Q=Σ(ΔQ_{ads})+Q_{L}).

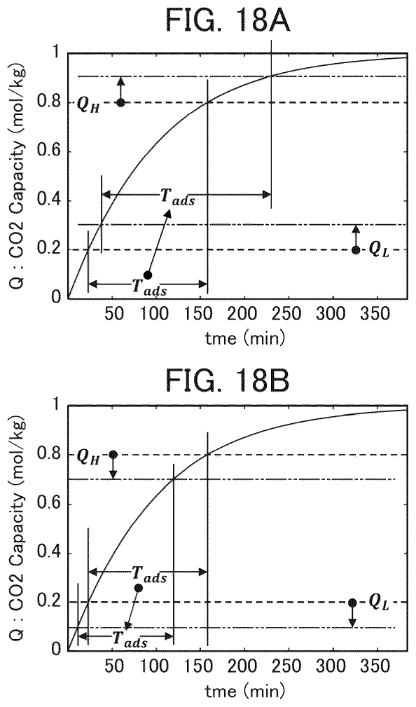

Since the adsorbed amount Q of carbon dioxide is estimated by successive integration, the integration error is accumulated by repeating the recovery mode and desorption mode. In the case of the lower limit Q_{L} and the upper limit Q_{H} of the working capacity being displaced in a direction approaching the equilibrium adsorption capacity Q*, as shown in FIG. 18A, since the difference between the upper limit Q_{H} of the working capacity and the equilibrium adsorption capacity Q* becomes smaller, the adsorption rate of carbon dioxide declines, and thus the operating time T_{ads} in the recovery mode becomes longer. In the case of the lower limit Q_{L} and the upper limit Q_{H} of the working capacity being displaced in a direction distancing from the equilibrium adsorption capacity Q*, as shown in FIG. 18B, since the difference between the upper limit Q_{H} of the working capacity and the equilibrium adsorption capacity Q* becomes larger, the adsorption rate of carbon dioxide rises, and thus the operating time T_{ads} in the recovery mode becomes shorter. Therefore, in the case of the operating time T_{ads} in the recovery mode deviating from a predetermined range, the carbon dioxide recovery device may be configured to perform operation in a reset mode that causes the carbon dioxide to desorb until the adsorbed amount Q of carbon dioxide on the adsorption unit is in the vicinity of 0, and causes the carbon dioxide to adsorb until the adsorbed amount Q of carbon dioxide on the adsorption unit is the lower limit Q_{L} of the working capacity, followed by performing the recovery mode. The reset mode may be performed after repeating operation of the recovery mode and desorption mode a predetermined number of times.

In addition, upon adjusting the drive force of the fan based on the carbon dioxide concentration of the air discharged from the flow path, the relationship between the drive force of the fan and the carbon dioxide concentration of air discharged from the flow path is a non-linear relationship, and a time delay occurs. For this reason, the adjustment of the carbon dioxide concentration of the air discharged from the flow path can be performed more accurately by applying a multivariable control system made considering the wind speed of air outdoors, humidity of air outdoors, temperature of air outdoors, performance of the adsorption material, presence/absence of portions in adsorption unit where pressure loss is low, fouling of the fan, etc.

Additionally, the first to fourth embodiments illustrate carbon dioxide recovery devices 1 that recover carbon dioxide in air; however, it is not to be limited thereto. The carbon dioxide recovery device of the present invention may be used in order to recovery carbon dioxide contained in a gas discharged from a boiler, for example.

### EXPLANATION OF REFERENCE NUMERALS

1 carbon dioxide recovery device
10 main body
11 flow path
11a air introduction port
11b air discharge port
14 aperture adjustment damper
20 fan
30 adsorption unit
40 controller
41 flowrate sensor
42 introduction-side carbon dioxide concentration sensor
43 discharge-side carbon dioxide concentration sensor

1. A carbon dioxide recovery device comprising:
a main body including a flow path through which a gas containing carbon dioxide flows;
a blower that introduces the gas to the flow path;
an adsorber that is arranged in the flow path and adsorbs the carbon dioxide contained in the gas introduced to the flow path;
a flowrate adjuster that adjusts a flowrate of the gas introduced to the flow path;
a discharge-side carbon dioxide concentration sensor that detects a concentration of carbon dioxide contained in a gas discharged from the flow path; and
a controller that adjusts a flowrate of gas introduced to the flow path by way of the flowrate adjuster, so that a concentration of carbon dioxide contained in the gas discharged from the flow path detected by the discharge-side carbon dioxide concentration sensor becomes a predetermined concentration of carbon dioxide.

2. The carbon dioxide recovery device according to claim 1,
wherein the flowrate adjuster is a fan constituting the blower, and adjusts the flowrate of the gas introduced to the flow path by adjusting a drive force thereof.

3. The carbon dioxide recovery device according to claim 1,
wherein the blower includes a plurality of fans, and
wherein the flowrate adjuster adjusts a number of fans to drive among the plurality of fans.
